(19) United States
(12) Patent Application Publication
(10) Pub. No.: US 2026/0208526 A1
(43) Pub. Date: Jul. 23, 2026

(54) EMBOSSED STRUCTURE

(71) Applicant: Lignum Technologies AG, Niederteufen (CH)

(72) Inventor: Hermann GFÖLLER, St. Koloman (AT)

(73) Assignee: Lignum Technologies AG, Niederteufen (CH)

(21) Appl. No.: 19/139,616

(22) PCT Filed: Dec. 16, 2022
(86) PCT No.: PCT/EP2022/086405

§ 371 Date: Jun. 16, 2025

(51) Int. Cl. B44C 5/04; B27M 1/00; B27N 7/00

(52) U.S. Cl. CPC B44C 5/04; B27M 1/003; B27N 7/005

(57) ABSTRACT

A panel, in particular wall, ceiling, furniture or floor panel, wherein the panel comprises: a carrier plate, such as a medium density fiber (MDF) plate, a high density fiber (HDF) plate or a particle plate; wherein the plate has an embossed structure on its main surface, wherein the embossed structure comprises one or more three-dimensional structures extending at least partially into the plate; and at least one lacquer layer applied on the embossed structure.

### 1. TECHNICAL FIELD

The present invention relates to a wall, ceiling, furniture or floor panel, wherein the panel has an embossed structure and a lacquer layer located thereon. The present invention further relates to a method for manufacturing a corresponding panel.

### 2. PRIOR ART

There are a plurality of different panels, such as wall, ceiling, furniture and floor panels. Furthermore, there is a wide range of manufacturing methods for panels.

There is currently a constant need to improve the properties of the panels and/or the corresponding manufacturing methods of such panels. In particular, it is of interest to improve a variety of different panel properties. These properties include, for example, environmental friendliness, such as recyclability, feel, appearance and/or durability, such as fire, moisture and/or scratch resistance.

In particular, it is of interest in the technical field of panels for floors (e.g. in the “floorfactory” field) to make the surfaces and especially the visible surfaces of the panels visually and haptically appealing. For this purpose, structures on the surface are used, for example. Likewise, the manufacturing methods for visually appealing panels, panels with improved haptic appearance and panels which are also durable at the same time should be aligned.

Known panels in such a technical field for visible surfaces comprise laminate panels which are inexpensive and simple to handle. Typically, they comprise a carrier plate which is manufactured from a medium density fiber (MDF) or high density fiber (HDF) material, which enables thermal recyclability.

In the prior art, known panels have, for example, lacquer structures which are applied by means of a structured lacquer application roller. This application of the lacquer takes place after coating, for example with a decorative layer. Thus, a structure is applied by means of a lacquer layer on the surface of the processed panel, whereby a raised structure can be produced.

The prior art has some disadvantages. Thus, for example, only raised structures can be produced. Consequently, there is an increased need for lacquer for producing the structures. Depending on the need and customer wishes, large quantities of lacquer can then be required, whereby the costs are increased. Also, in corresponding manufacturing methods, the application quantity of the lacquer must be adapted locally in order to produce desired structures. A further disadvantage of known approaches in the prior art is that the flexibility of the visual design of the panel is reduced by the order of the working steps.

In view of the above disadvantages, there is an increased need to provide improved panels and improved manufacturing methods for these panels.

Thus, it is an object of the present invention to at least partially overcome the above-mentioned disadvantages. In particular, it is an object of the present invention to provide a panel which has improved visual and haptic properties. In addition, a corresponding manufacturing method for the panel is to be provided.

### 3. SUMMARY OF THE INVENTION

The objects are at least partially achieved by a panel and a method for manufacturing a panel as defined in the independent claims. Further aspects of the present disclosure are defined in the dependent claims. Since the panel and the method for manufacturing a panel both relate to panels, it goes without saying that advantages and/or features of the panel can also apply to the method and vice versa.

In particular, the object is achieved by a panel, in particular wall, ceiling, furniture or floor panel, wherein the panel comprises:
a carrier plate, such as a medium density fiber (MDF) plate, a high density fiber (HDF) plate or a particle plate;
   wherein the plate has an embossed structure on its main surface, wherein the embossed structure comprises one or more three-dimensional structures extending at least partially into the plate; and
at least one lacquer layer applied on the embossed structure.

This has the advantage that the carrier plate is provided with an embossed structure, wherein a lacquer layer is located thereon. Thus, the structure can already be introduced into the carrier plate in a simplified manner. Thus, the application of different lacquer layer thicknesses is unnecessary in order to produce structures.

A further advantage is that the structures are embossed, thus extend into the plate. Thus, no elevations would have to be produced for a structure. This can be advantageous if, for example, objects are to be placed on the panel. Thus, unevennesses resulting from different elevations can be reduced. It can also result in advantages with regard to haptic properties, since the panel feels flatter.

The lacquer layer is applied on the embossed structure. With regard to the chronological order in the manufacture of the panel, this is to be understood as meaning that the lacquer layer is applied after the embossing. The lacquer layer can accordingly advantageously be embodied such that it is useful for its purpose: the lacquer layer can thus provide sufficient elasticity to compensate for a deformation of the plate. It can also be possible to apply a lacquer layer which is based on a harder, i.e. less elastic, material. A higher resistance to impacts, scratches and/or chemicals can thereby be achieved. Suitable lacquer layers which can be used herein comprise, in a non-exhaustive list, corundum particles, acrylate, polymers, oligomers, additives and/or the like. Furthermore, the lacquer layer can be applied by means of flexography or any other type of application technique.

Thus, the lacquer layer is not necessarily to be understood as a lacquer layer with which elevations are produced.

The lacquer layer is applied “on” the embossed structure, which is to be understood such that a further layer (such as e.g. a decorative layer) can be arranged between the lacquer layer and the plate.

Overall, the arrangement contributes to an improved appearance and the manufacturing method can be embodied in a simplified and cost-effective manner.

The carrier plate (also referred to herein as “plate” for brevity) can be a plate which is manufactured from a wood-based material, such as a medium density fiber plate or a high density fiber plate, a particle plate, an oriented strand plate or the like. However, it can also be manufactured from a plastic material, such as luxury vinyl tile (LVT), a rigid polymer core or an expanded polymer core as well as mixed constructions which are widely used in the floor industry. High density fiber (HDF) plates enable good recyclability.

The term “three-dimensional” is to be understood in the context of the embossed structure of the present disclosure such that the embossed structure has an extension at least discernibly in three spatial directions.

Preferably, the one or more three-dimensional structures extend by at least 0.02 mm, preferably at least 0.03 mm, more preferably at least 0.04 mm, most preferably at least 0.05 mm into the plate. Alternatively or additionally, the one or more three-dimensional structures extend by at most 3.0 mm, preferably at most 2.5 mm, more preferably at most 2.0 mm, more preferably at most 1.8 mm, most preferably at most 1.5 mm into the plate.

This has the advantage that the three-dimensional structures are visible and thus provide a correspondingly improved appearance. For example, the three-dimensional structures could serve to reinforce and/or imitate a pattern of a decorative printing layer.

The extension of the three-dimensional structures into the plate has proven to be small enough, on the one hand, so that the panel does not experience too strong a mechanical weakening. Consequently, a high robustness and a wide range of application of the panels is ensured. On the other hand, the extension of the three-dimensional structures into the plate has proven to be large enough to ensure a sufficient improvement in visual and haptic properties. The inventors have thus succeeded in identifying a sufficient compromise of the extension, wherein the opposing objectives can be duly taken into account.

Preferably, the one or more three-dimensional structures cover at least 0.5%, preferably at least 1%, more preferably at least 2%, more preferably at least 3%, more preferably at least 4%, more preferably at least 5%, more preferably at least 6%, more preferably at least 7%, most preferably at least 8% of the main surface. In other examples, it can also cover at least 9%, 10%. Alternatively or additionally, the one or more three-dimensional structures cover at most 95%, preferably at most 90%, more preferably at most 80%, more preferably at most 60%, more preferably at most 50%, more preferably at most 40%, more preferably at most 30%, more preferably at most 20%, most preferably at most 10% of the main surface.

This offers the advantage that the one or more three-dimensional structures are discernible and thus contribute to the improvement in the visual and haptic properties.

The coverage of the main surface specified herein has proven to be sufficient, on the one hand, to enable an improvement in the visual and haptic properties (large coverage desirable), while, on the other hand, no strong influence on mechanical properties of the carrier plate occurs (low coverage desirable). In this way, a meaningful compromise of the coverage could be achieved.

In an embodiment of the panel, the one or more three-dimensional structures are arranged on one or more first regions of the main surface, wherein the main surface has a second region without three-dimensional structures.

One or more first regions may be provided. If a plurality of first regions are provided, usually a respective three-dimensional structure is arranged in a respective first region. A three-dimensional structure may have different extensions into the plate. Insofar as the extensions are visible, a first region is usually referred to. If the extension at a point of the main surface is negligibly small and is greater directly adjacent to this point, a further three-dimensional structure and consequently a further first region may be referred to.

The regions in which no three-dimensional structures are discernible for the person skilled in the art without any aids are referred to herein as the second region. The person skilled in the art is able to make such a distinction.

Preferably, a circumference of one or more of the first regions of the main surface has the lacquer layer applied thereon with at least 10%, preferably at least 20%, more preferably at least 30%, most preferably at least 50% of an average thickness of the lacquer layer.

This has the advantage that a sufficient lacquer layer thickness is provided on the circumference of the one or more first regions. The circumference of the first region or the circumferences of the plurality of first regions may be exposed to higher mechanical loads, for example. Thus, a sufficient lacquer layer thickness promotes the longevity of the panel.

The circumference of the first region or the circumferences of the plurality of first regions may be understood as the transition from the embossed structure to the main surface of the panel. Thus, the circumference or the circumferences may also be understood as an edge or edges.

It should be mentioned that, for example, three-dimensional structures introduced subsequently (after applying the lacquer layer) into the panel (accidentally) damage the panel. Consequently, this leads to the fact that no lacquer layer is present at the edge described herein.

Preferably, the circumference of one or more of the first regions of the main surface is composed of a plurality of the following lines: a straight line, a zigzag line, a circle segment line, a rounded segment line, an elliptical segment line, a corner, preferably the circumference is composed of a plurality of these lines in a random order.

This offers advantages with regard to the design of the one or more first regions of the main surface. Thus, visual and haptic improvements can be achieved.

Preferably, the width of one or more of the first regions of the main surface perpendicular to a longitudinal extension of the plate compared to the width of the plate is at least 0.05%, preferably at least 0.1%, more preferably at least 0.15%, more preferably at least 0.2%, more preferably at least 0.5%, more preferably at least 1.0%, more preferably at least 1.5%, more preferably at least 2.0%, more preferably at least 3.0%, more preferably at least 4.0%, most preferably at least 5.0%. Alternatively or additionally, the width of one or more of the first regions of the main surface perpendicular to a longitudinal extension of the plate compared to the width of the plate is at most 90%, preferably at most 85%, more preferably at most 80%, more preferably at most 70%, more preferably at most 60%, more preferably at most 50%, more preferably at most 45%, more preferably at most 40%, more preferably at most 35%, more preferably at most 30%, more preferably at most 25%, more preferably at most 20%, more preferably at most 15%, most preferably at most 10%.

These widths have proven to be sufficient, on the one hand, to provide an improved visual and haptic quality, while, on the other hand, the robustness and mechanical integrity are likewise kept at a high level. Smaller widths may also be advantageous since, thus, a larger number of first regions can be arranged on the main surface.

The plate typically has a longitudinal extension (length) and a width perpendicular to the longitudinal extension. The width of the plate is typically small compared to the length. The width of one or more of the first regions described herein is consequently to be determined along the same direction as the width of the plate.

Preferably, a thickness of the plate and the lacquer layer at the first regions is smaller compared to the thickness of the plate and the lacquer layer at the second region.

This has the advantage that the lacquer layer does not significantly adversely affect the provision of the three-dimensional structure(s) in the first region(s).

Thus, when lacquer layer is present, the three-dimensional structures are still discernible. Consequently, this promotes the visual, haptic and mechanical properties of the panel.

The thickness is measured substantially perpendicular to the longitudinal extension and substantially perpendicular to the width of the plate.

In a further embodiment of the panel, the panel further comprises one of the following layers in the stated order seen from the main surface and below the lacquer layer:
a primer layer; and
optionally a decorative printing layer.

The primer layer enables the decorative printing layer to be applied with sufficient quality. This improves the application of the decorative printing layer. It is understood that the primer layer is applied directly below the decorative printing layer.

The decorative printing layer is applied such that it can be seen, for example, from the upper side of the panel when the plate is located in a typical position, for example on a floor, a wall, a ceiling or the like. The upper side/main surface of the panel is usually opposite a rear surface of the panel. This allows the printing layer and the decorative aspect of the printing layer to be better highlighted.

The rear surface of the panel can be configured to be applied to a base surface, for example a wall, ceiling or floor surface. In one example, the rear surface can be provided with adhesives and/or mechanical attachment means.

The decorative printing layer can comprise a decorative pattern. The decorative pattern can imitate any desired appearance. In one example, the decorative pattern can imitate a natural surface.

Preferably, the lacquer layer is applied directly above the decorative printing layer, optionally wherein the decorative printing layer is applied directly above the primer layer, optionally wherein the primer layer is applied directly above the plate and the embossed structure.

In a further embodiment, the panel further comprises:
a wear layer applied directly above the lacquer layer.

The wear layer can be applied by means of melt lamination or adhesive lamination in one example. Optionally, the wear layer can be based on cast polypropylene.

The wear layer has the advantage that the protection of the panel is further improved. In particular, the wear layer can protect the decorative printing layer.

The wear layer is applied directly above the lacquer layer, which is to be understood such that the wear layer does not substantially contact the plate. Further, “directly above” may be understood in one example such that no further layer can be arranged therebetween.

In one example, the decorative printing layer contacts the primer layer, the lacquer layer contacts the decorative printing layer and the wear layer contacts the lacquer layer. Thereby, the layers can be applied to the plate in the following order as seen from the plate: the primer layer, the decorative printing layer, the lacquer layer, the wear layer.

The objects of the present invention are further at least partially achieved by a method for manufacturing a panel, in particular wall, ceiling, furniture or floor panel, comprising the following steps:
providing a carrier plate, such as a medium density fiber (MDF) plate or a high density fiber (HDF) plate or a particle plate;
embossing the plate using an embossing structure, such as an embossing roller, for providing the plate with an embossed structure on its main surface, wherein the embossed structure comprises one or more three-dimensional structures extending at least partially into the plate;
applying, after embossing the plate, at least one lacquer layer on the embossed structure.

It goes without saying that substantially the same advantages and features mentioned with regard to the panel apply equally to the method for manufacturing a panel. The features can thus also be applied in combination and/or interchangeably to embodiments of the panel or of the method.

The method comprises one or more steps of applying layers which do not necessarily have to be connected during the application. Also, in the method for manufacturing a panel, during the application of the layers, the layers can be at least partially viscous/liquid.

Preferably, applying the lacquer layer comprises applying the lacquer layer with a substantially constant thickness.

This has the advantage that no unnecessary lacquer has to be applied in order to provide structures in the plate.

Preferably, providing the carrier plate comprises formatting an initial carrier plate into one or more carrier plate(s).

An initial (large) carrier plate can consequently be formatted into the carrier plate. Thus, the plate is suitable to be used directly in a respective area of application. As a result, for example, no formatting is required in a subsequent method step, for example embossing. Further advantages are described herein with regard to the panel.

In an example, the plate has a width (w) of at least 4 cm and/or of at most 200 cm.

Preferably, the method further comprises profiling the plate for providing a connecting structure on at least one side surface of the plate, wherein the side surface is substantially perpendicular to the main surface of the plate, preferably directly after embossing the plate.

The side surface of the plate is substantially perpendicular to the upper side/main surface of the plate. Profiling enables the plate to be connected to another plate. This can take place, for example, by positive locking. The connecting structure enables the side surface to be configured to be engaged with a side surface of another plate. Profiling can also comprise providing a connecting structure on both side surfaces.

Preferably, the method further comprises applying, after embossing the plate, a primer layer on the plate. Respective advantages are described herein with regard to the panel.

Preferably, the method further comprises applying, optionally after embossing the plate, a decorative printing layer on the plate, further optionally after applying the primer layer, preferably by means of rotogravure printing, flexography and/or digital printing. Respective advantages are described herein with regard to the panel.

Preferably, applying the lacquer layer is performed after applying the decorative printing layer. Consequently, the lacquer layer is above the decorative printing layer. Respective advantages are described herein with regard to the panel.

Preferably, the method further comprises applying, optionally after applying the lacquer layer, a wear layer on the plate, further optionally applying the wear layer by means of melt lamination or adhesive lamination, optionally wherein the wear layer is based on cast polypropylene. Respective advantages are described herein with regard to the panel.

An embodiment relates to the panel and/or the method for manufacturing the panel, wherein the plate has a thickness of at least 1 mm, preferably at least 2 mm, more preferably at least 3 mm, more preferably at least 4 mm, more preferably at least 5 mm, more preferably at least 6 mm, more preferably at least 7 mm, most preferably at least 7.5 mm. Alternatively or additionally, the plate has a thickness of at most 40 mm, preferably at most 35 mm, more preferably at most 30 mm, more preferably at most 25 mm, more preferably at most 20 mm, more preferably at most 18 mm, more preferably at most 14 mm, most preferably at most 10 mm.

These thicknesses have proven to be sufficient, on the one hand, to provide a sufficient rigidity and to offer a high wear resistance, while, on the other hand, the material use is kept at a moderate level.

A further embodiment relates to the panel and/or the method for manufacturing the panel, wherein the lacquer layer has a thickness of at least 10 μm, preferably at least 20 μm, more preferably at least 30 μm, more preferably at least 50 μm, more preferably at least 60 μm, more preferably at least 70 μm, more preferably at least 80 μm, most preferably at least 90 μm. Alternatively or additionally, the lacquer layer has a thickness of at most 400 μm, preferably at most 300 μm, more preferably at most 200 μm, more preferably at most 150 μm, more preferably at most 120 μm, most preferably at most 110 μm.

These lacquer layer thicknesses have proven to be advantageous in order to provide a stable, wear-resistant and visually as well as haptically appealing panel.

Preferably, the one or more three-dimensional structures are arranged on the main surface so as to imitate a natural pattern, in particular a wood and/or stone pattern.

This contributes to an improved appearance and increases the quality of the corresponding panel. The three-dimensional structures described herein are to be understood as those which have been introduced into the carrier plate in a targeted and intentional manner. The person skilled in the art understands this in particular in that, for example, a pattern can be reproduced in this way.

Preferably, the one or more three-dimensional structures do not have a defined geometric shape, such as a triangle, a circle, an ellipse, a rectangle, in particular a parallelogram, a trapezium.

The geometric shape described herein can be seen from above, i.e. for example with a viewing direction towards the main surface of the panel. This has the advantage that a natural and improved appearance is provided. Nevertheless, in some cases, compositions of individual geometric shapes can also lead to an undefined geometric shape, which can also be recognized as such an undefined geometric shape.

Preferably, the one or more three-dimensional structures are arranged unevenly and/or randomly on the main surface.

This offers advantages with regard to the provision of the three-dimensional structures and the appearance of the entire panel. The three-dimensional structures described herein can be provided, for example, by an embossing machine with corresponding projections.

### 4. BRIEF DESCRIPTION OF THE ACCOMPANYING FIGURES

In the following, preferred embodiments are described only by way of example. Reference is made to the following accompanying Figures:

FIG. 1 shows a schematic cross section of a panel according to an embodiment of the present disclosure;

FIG. 2 shows the embodiment of FIG. 1 in a plan view from above the panel;

FIG. 3 shows a schematic cross section of a panel according to an embodiment of the present disclosure, wherein further layers are comprised; and

FIG. 4 shows a diagram of an exemplary method according to an embodiment of the present disclosure.

### 5. DETAILED DESCRIPTION OF THE FIGURES

In the following, preferred embodiments are illustrated, mainly with reference to the above Figures. It is pointed out that further embodiments are certainly possible and the following explanations are to be understood only by way of example and without limitation. Further, the present invention can also be used in other embodiments which are not explicitly disclosed in the following.

Furthermore, as described in detail in the following, the embodiments are compatible with one another and individual features of an embodiment can also be applied to another embodiment.

It is understood that the dimensions of the Figures are merely schematic in nature and thus are not drawn to scale.

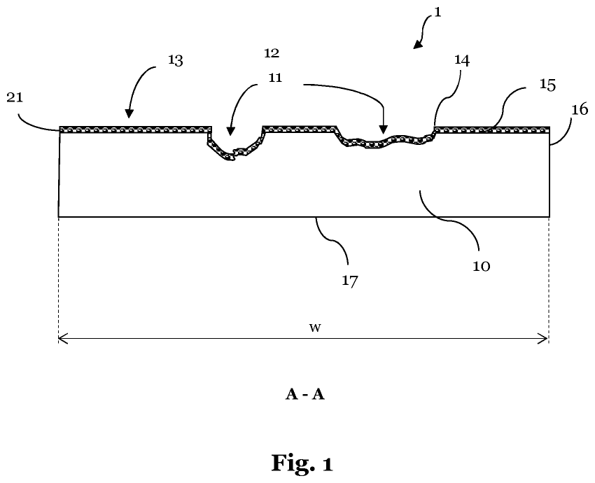

FIG. 1 shows a schematic cross section of a panel 1 according to an embodiment of the present disclosure. The panel 1 can be a wall, ceiling, furniture or floor panel. The panel 1 can also be used as a worktop or as a vertical surface, such as in furniture fronts or doors. The panel 1 comprises a carrier plate 10, such as a medium density fiber (MDF) plate, a high density fiber (HDF) plate or a particle plate. The plate 10 has an embossed structure 11 on its main surface 15, wherein the embossed structure 11 comprises one or more three-dimensional structures 11 extending at least partially into the plate 10. The panel 1 further comprises at least one lacquer layer 21 applied on the embossed structure 11. In this cross-sectional view, two three-dimensional structures 11 are discernible. This extend by at least 0.02 mm and by at most 3 mm into the carrier plate 10.

Further, two first regions 12 are indicated, wherein the two three-dimensional structures 11 are arranged on the two first regions 12 of the main surface 15. In addition, a second region 13 without a three-dimensional structure 11 is illustrated. The circumference 14 of the first regions 12 of the main surface 15 has a lacquer layer 21, wherein the thickness of the lacquer layer at the circumference 14 has at least 10%, 20% or 30% of an average thickness of the lacquer layer 21.

The plate 10 has a rear surface 17. The rear surface 17 typically faces a floor, a wall, a ceiling or the like, depending on the field of application of the panel 1. The main surface 14 is usually visible and opposite the rear surface 17. The panel 1 can also comprise a connecting structure (not illustrated) on at least one side surface 16 of the plate 10.

Further, it is discernible that the thickness of the plate 10 and the lacquer layer 21 at the first regions 12 is smaller compared to the thickness of the plate 10 and the lacquer layer 21 at the second region 13.

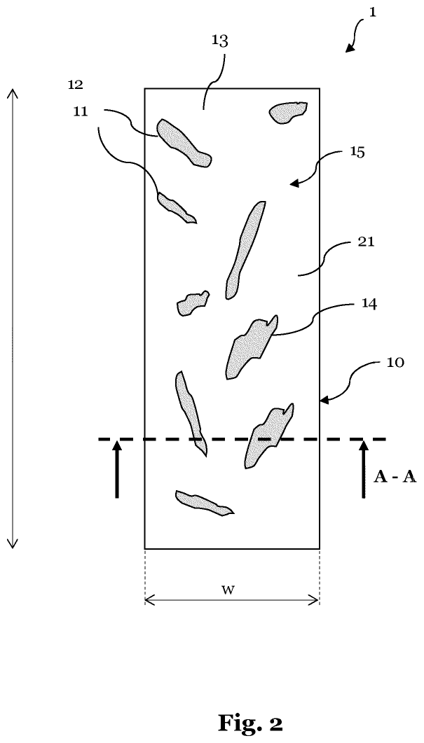

FIG. 2 shows the embodiment of FIG. 1 in a plan view. Herein, also the cross section A-A of FIG. 1 is schematically indicated. It is evident that a plurality of three-dimensional structures 11 (only two are indicated) and first regions 12 (only two are indicated) are comprised by the panel 1. The longitudinal extension L and the width w of the panel 1 are also illustrated.

The extension of the three-dimensional structures 11 takes place in FIG. 2 into the image plane. Thus, the extension is for example perpendicular to the main surface 15 of the plate 1.

It is discernible that the circumference 14 (only one is indicated) of the plurality of first regions 12 of the main surface 15 is composed of a plurality of the following lines: a straight line, a zigzag line, a circle segment line, a rounded segment line, an elliptical segment line, a corner.

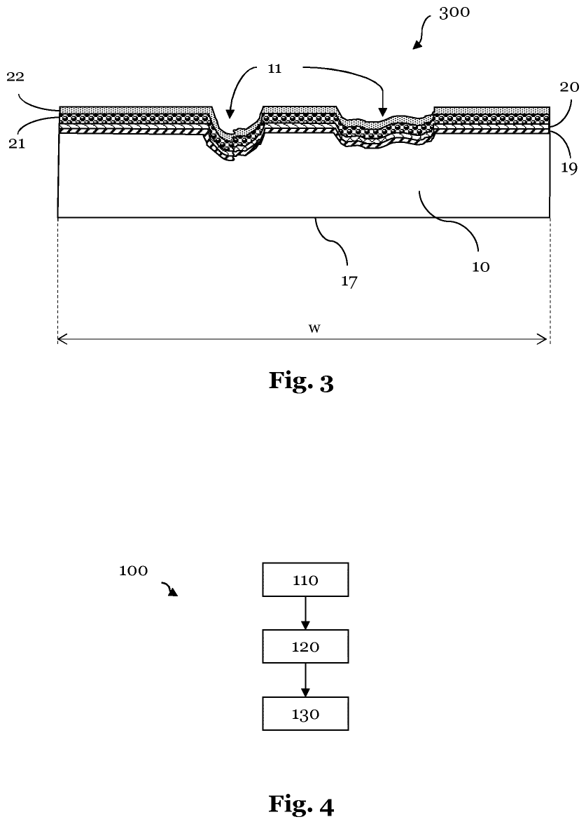

FIG. 3 shows a schematic cross section of a panel 300 according to an embodiment of the present disclosure, wherein further layers are comprised. The panel 300 is similar to the panel 1 of the embodiment of FIG. 1 and only the differences are described. The panel 300 further comprises a primer layer 19 applied directly above the plate 10 on the plate 10. Further, a decorative printing layer 20 is illustrated. The decorative printing layer 20 is applied directly above the primer layer 19 (as seen from the plate 10). The panel 300 further comprises a wear layer 22 applied directly above the lacquer layer 21 (as seen from the plate 10). The arrangements of the layers and the order are evident from FIG. 3.

The layers above the decorative printing layer 20 are configured such that the decorative printing layer 20 can be seen from above (for example in the Figure in a vertical direction from top to bottom). The three-dimensional structures 11 can serve to reinforce and/or imitate a pattern of a decorative printing layer.

It is emphasized that the relation of the extension of the three-dimensional structures 11 and the thicknesses of the layers 19, 20, 21 and 22 as well as the thickness of the carrier plate 10 deviate from one another in reality and the Figure is thus merely schematic in nature.

FIG. 4 shows a diagram of an exemplary method 100 according to an embodiment of the present disclosure.

The method 100 for manufacturing a panel 1, in particular wall, ceiling, furniture or floor panel, comprises the following steps:
providing 110 a carrier plate, such as a medium density fiber (MDF) plate or a high density fiber (HDF) plate or a particle plate;
embossing 120 the plate using an embossing structure, such as an embossing roller, for providing the plate with an embossed structure on its main surface, wherein the embossed structure comprises one or more three-dimensional structures extending at least partially into the plate;
applying 130, after embossing the plate, at least one lacquer layer on the embossed structure.

It is noted that the above examples can be combined with further aspects as described herein and details of the examples can also be omitted, as the person skilled in the art will understand. The scope is determined by the claims and is not limited by the embodiments disclosed in the above Figures.

It will be apparent to the person skilled in the art that numerous modifications and variations of the described examples and embodiments are possible in view of the above teaching. The disclosed examples and embodiments are presented for illustrative purposes only. Other embodiments can comprise some or all of the features disclosed herein. Therefore, it is intended to cover all such modifications and alternative embodiments which can fall within the true scope of this invention.

### 6. LIST OF REFERENCE SIGNS

1, 300 Panel
10 Carrier plate
11 Three-dimensional structures
12 First region/first regions
13 Second region/second regions
14 Circumference of the first region/first regions
15 Main surface
16 Side surface
17 Rear surface
19 Primer layer
20 Decorative printing layer
21 Lacquer layer
22 Wear layer
L Longitudinal extension
w width
100 Method
110 providing
120 embossing
130 applying

1. A panel, in particular wall, ceiling, furniture or floor panel, wherein the panel comprises:
a carrier plate, such as a medium density fiber (MDF) plate, a high density fiber (HDF) plate or a particle plate;
wherein the plate has an embossed structure on its main surface, wherein the embossed structure comprises one or more three-dimensional structures extending at least partially into the plate; and
at least one lacquer layer applied on the embossed structure.

2. The panel according to claim 1, wherein the one or more three-dimensional structures extend by at least 0.02 mm,
and/or by at most 3.0 mm into the plate.

3. The panel according to claim 1, wherein the one or more three-dimensional structures extend by at least 0.5%, and/or by at most 95%.

4. The panel according to claim 1, wherein the one or more three-dimensional structures are arranged on one or more first regions of the main surface and wherein the main surface has a second region without three-dimensional structures.

5. The panel according to claim 4, wherein a circumference of one or more of the first regions of the main surface has the lacquer layer applied thereon with at least 10% of an average thickness of the lacquer layer.

6. The panel according to claim 4, wherein a circumference of one or more of the first regions of the main surface is composed of a plurality of the following lines: a straight line, a zigzag line, a circle segment line, a rounded segment line, an elliptical segment line, a corner, preferably the circumference is composed of a plurality of these lines in a random order.

7. panel according to claim 4, wherein the width of one or more of the first regions of the main surface perpendicular to a longitudinal extension of the plate compared to the width of the plate is at least 0.05%, and/or
at most 90%.

8. The panel according to claim 4, wherein a thickness of the plate and the lacquer layer at the first regions is smaller compared to the thickness of the plate and the lacquer layer at the second region.

9. The panel according to claim 1, further comprising the following layers in the stated order seen from the main surface and below the lacquer layer:
a primer layer; and
a decorative printing layer.

10. The panel according to claim 9, wherein the lacquer layer is applied directly above the decorative printing layer, optionally wherein the decorative printing layer is applied directly above the primer layer, optionally wherein the primer layer is applied directly above the plate and the embossed structure.

11. The panel according to claim 1, further comprising:
a wear layer applied directly above the lacquer layer.

12. A method for manufacturing a panel, in particular wall, ceiling, furniture or floor panel, comprising the following steps:
providing a carrier plate, such as a medium density fiber (MDF) plate or a high density fiber (HDF) plate or a particle plate;
embossing the plate using an embossing structure, such as an embossing roller, for providing the plate with an embossed structure on its main surface, wherein the embossed structure comprises one or more three-dimensional structures extending at least partially into the plate;
applying, after embossing the plate, at least one lacquer layer on the embossed structure.

13. The method according to claim 12, wherein applying the lacquer layer comprises:
applying the lacquer layer with a substantially constant thickness.

14. The method according to claim 12, wherein providing the carrier plate comprises:
formatting an initial carrier plate into one or more carrier plate(s).

15. The method according to claim 12, further comprising:
profiling the plate for providing a connecting structure on at least one side surface of the plate, wherein the side surface is substantially perpendicular to the main surface of the plate, preferably directly after embossing the plate.

16. The method according to claim 12, further comprising:
applying, after embossing the plate, a primer layer on the plate.

17. The method according to claim 12, further comprising:
applying, after embossing the plate, a decorative printing layer on the plate, optionally after applying the primer layer, preferably by means of rotogravure printing, flexography and/or digital printing.

18. The method according to claim 17, wherein applying the lacquer layer is performed after applying the decorative printing layer.

19. The method according to claim 12, further comprising:
applying, after applying the lacquer layer, a wear layer on the plate, optionally applying the wear layer by means of melt lamination or adhesive lamination, optionally wherein the wear layer is based on cast polypropylene.

20. The panel according to claim 1, wherein the plate has a thickness of at least 1 mm and/or at most 40 mm,

21. The panel claim 1, wherein the lacquer layer has a thickness of at least 10 μm, and/or at most 400 μm.

22. The panel according to claim 1, wherein the one or more three-dimensional structures are arranged on the main surface to imitate a natural pattern, in particular a wood and/or stone pattern.

23. The panel according to claim 1, wherein the one or more three-dimensional structures do not have a defined geometric shape, such as a triangle, a circle, an ellipse, a rectangle, in particular a parallelogram, a trapezium.

24. The panel according to claim 1, wherein the one or more three-dimensional structures are arranged unevenly and/or randomly on the main surface.
